(19) United States
(12) Patent Application Publication
(10) Pub. No.: US 2013/0020005 A1
(43) Pub. Date: Jan. 24, 2013

(54) APPLICATORS FOR ALIGNING PROTECTIVE FILMS ON DEVICE SURFACES

(71) Applicants: Yeshaya A. Koblick, Sharon, MA (US); Akash Joseph Abraham, Hoboken, NJ (US)

(72) Inventors: Yeshaya A. Koblick, Sharon, MA (US); Akash Joseph Abraham, Hoboken, NJ (US)

(21) Appl. No.: 13/187,161

(22) Filed: Jul. 20, 2011

(51) Int. Cl. B32B 37/00; B32B 37/12

(52) U.S. Cl. 156/60; 156/538

(57) ABSTRACT

A device surface of a device (e.g., a screen or touchpad of a mobile phone or a portable media player) may be protected from damage by the application of a protective film with an adhesive. However, it may be difficult for a user to achieve an accurate alignment of the film with the device surface, resulting in cosmetic and functional disadvantages. Presented herein are techniques for achieving an accurate alignment of the film to the device surface through the use of an applicator, comprising one or more anchors that respectively couple with one or more projections of the device surface (e.g., a plug conformant with a headphones port). The film may be positioned with respect to the applicator, such that when the anchors of the applicator couple with corresponding surface projections of the device surface, the film is accurately and precisely aligned with the device surface.

### BACKGROUND

Within the field of electronics, many scenarios involve a portable device, such as a mobile phone, a tablet, a media player, a global positioning service (GPS) receiver, and a personal data assistant. Such devices may feature a device surface (e.g., a screen, a touchpad, or a camera lens) that may be susceptible to various types of damage upon exposure to pressure, scratches, sunlight, water, or chemicals. Even surfaces of the device that are primarily structural (e.g., a bezel of a screen or a back of the device) may be susceptible to cosmetic damage, such as scratches that may disrupt a smooth finish of the surface.

In order to protect such device surfaces, protective films have been devised that may be overlaid upon the device surface to reduce damage from various sources. For example, the film may be transparent and semi-transparent to visible light (e.g., passing most or all of the light emitted by a backlit screen) and may permit some other forms of input and output (e.g., films that present a compatibility with capacitative touchscreens by not obscuring the effects of skin contact), but may filter out ultraviolet light that may damage the screen; may absorb shocks and scratches; and may provide resistance for incidental exposure to water. Such films are often provided with an adhesive that enables adherence of the film to the device surface, and may be fabricated from inexpensive materials that enable easy replacement (e.g., if the film becomes discolored or scratched, or if the adhesive adhering the film to the device surface loses strength).

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

A problem that may often arise while applying and using a protective film is the proper alignment of the film with respect to the device surface. As a first example, a film may attach to the device surface with a static adhesive, such that once attached to the device surface, the film tightly adheres and cannot be easily repositioned. However, it may be very difficult for a user to choose a precise and accurate alignment of the film with the device surface upon first contact, and attempting to realign the film may involve breaking the static adhesive, resulting in a weaker final adhesion of the film to the device surface. As a second example, a film may attach to a device surface with a dynamic adhesive that is initially movable, and that gradually activates to provide stronger adherence and resist relocation (e.g., an adhesive fluid that provides little adherence upon application of the film, but that gradually dries into an activated adhesive that tightly adheres the film to the selected alignment of the device surface). However, the application of a film coated with fluid adhesive to a device surface often traps air bubbles that reduce the cosmetic quality of the device and that impair the functionality of the device surface (e.g., by presenting irregularities in the display presented by a screen, or by reducing the consistent sensitivity of a touchpad). Moreover, while a fluid adhesive may enable the user to reposition the film, the repositioning process may be frustrating to the user, and the manual involvement of the user may lead to a diminished final result (e.g., a lateral misalignment of the film that results in a difference between the width of the film at the left edge of the device surface and the width of the film at the right edge of the device surface).

Presented herein are techniques for promoting the alignment of a film with a device surface. These techniques involve an applicator comprising at least one anchor that is conformant with at least one surface projection of a device surface, such as an aperture (e.g., a headphones port) or a protrusion (e.g., a raised button, switch, or antenna). For example, the anchor may comprise a protrusion that is shaped and positioned on the applicator to couple with a headphones port or a data port of the device, or an aperture that is shaped and positioned on the applicator to couple with a raised button or switch of the device. The applicator is also coupled with the film in such a manner that when the anchor of the applicator is coupled with the surface projection of the device surface, the film is accurately aligned with the device surface. The surface of the film oriented toward the device screen is coated with a surface adhesive that tightly adheres to the device surface. Having been aligned with and adhering to the device surface, the film may be decoupled from the applicator (e.g., by peeling the applicator away from the film and device surface, thereby breaking a weak applicator adhesive coupling the applicator with the film). Moreover, if the surface adhesive comprises a fluid that is initially deactivated, the applicator may include a squeegee guide, which, when coupled with a squeegee, may guide the squeegee over the film, thereby promoting removal of air bubbles trapped by the fluid adhesive. In this manner, the techniques presented herein may be used to align the film with the device surface in an accurate manner with little or no manual positioning by the user, and may assist in the removal of air bubbles trapped in the surface adhesive.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is an illustration of an exemplary scenario featuring an application of a protective film to a device surface of a device.

FIG. 2 is an illustration of an exemplary scenario featuring another application of a protective film to a device surface of a device.

FIG. 3 is an illustration of an exemplary scenario featuring a front view of an applicator that facilitates the alignment of a film with a device surface of a device in accordance with the techniques presented herein.

FIG. 4 is an illustration of an exemplary scenario featuring a side view of an applicator that facilitates the alignment of a film with a device surface of a device in accordance with the techniques presented herein.

FIG. 5 is an illustration of a flow diagram presenting an exemplary method of applying a film to a device surface of a device in accordance with the techniques presented herein.

FIG. 6 is an illustration of a flow diagram presenting another exemplary method of applying a film to a device surface of a device in accordance with the techniques presented herein.

FIG. 7 is an illustration of an exemplary applicator comprising some additional features that facilitate the application of a film to a device surface in accordance with the techniques presented herein.

FIG. 8 is an illustration of an exemplary scenario featuring the use of an applicator to apply a film to a device surface in accordance with the techniques presented herein.

FIG. 9 is an illustration of an exemplary scenario featuring the use of a squeegee and a tray having squeegee guides to remove air bubbles trapped within the surface adhesive between a film and a device surface in accordance with the techniques presented herein.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are shown in block diagram form in order to facilitate describing the claimed subject matter.

### A. Introduction

Within the field of electronics, many scenarios involve a device having a device surface. The range of such devices includes communications devices, such as mobile phones and text messaging devices; tablet- and palm-factor computers; personal data assistants; cameras; portable media players, such as music players, video players, and gaming devices; and global positioning system (GPS) receivers. These and other portable devices may be equipped with various types of device surfaces, such as a display; user input devices, such as touchscreens, touchpads, and keypads; media input devices, such as still image cameras, video cameras, and microphones; sensors, such as temperature sensors, light meters, and antennae; and structural surfaces, such as a bezel surrounding a display, a handpiece providing a surface to grip or hold the device, and a case or shield.

These types of portable devices may be exposed to many forces, including physical forces such as scratches, pressure, puncture, and physical shock; excessive heat or light, including ultraviolet light; and chemicals, such as water and spilled drinks. Such forces may cause various types of damage the device surfaces, including cosmetic damage (e.g., a marred finish of the device surface), structural (e.g., cracks), and functional (e.g., damaged input or output devices). Therefore, it may be desirable to protect against damage to the device surfaces, particularly with a comparatively inexpensive and replaceable element that may absorb damage to the surface of a comparatively expensive and irreplaceable device. Many such elements are devised as a transparent or semi-transparent film that may be overlaid upon part or all of the device surface, adhering to the device surface with a type of adhesive. For example, the film may be selected from a polymer that passes through most or all visible light (e.g., light generated from a backlit display), and that blocks ultraviolet light that may discolor the device surface (e.g., in the event of prolonged exposure to sunlight). Alternatively or additionally, the polymer may deflect or absorb forces, such as scratches from physical objects, and/or exposure to chemicals such as water. Many types of films may be utilized to reduce many types of damage to the device surfaces of various types of devices.

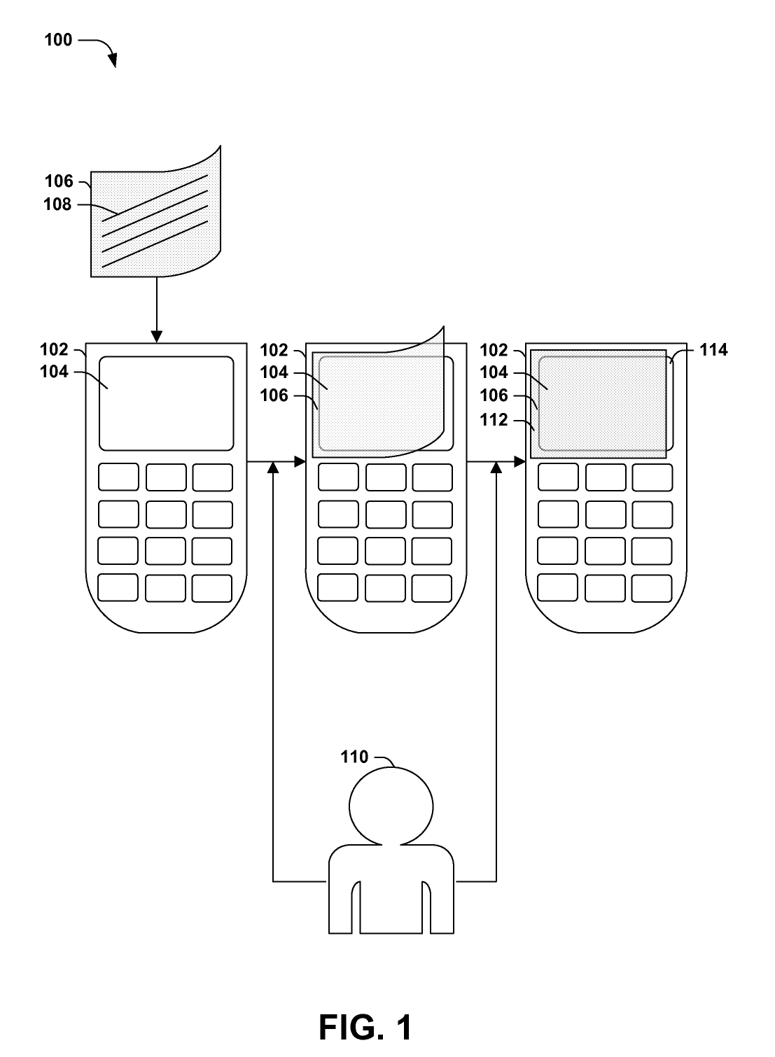

FIG. 1 presents an illustration of an exemplary scenario 100 featuring a device 102 having a device surface 104 (in this exemplary scenario 100, a screen) that a user 110 of the device 102 may wish to protect from damage. This protection may be achieved by providing a film 106 that is approximately sized to the device surface 104 (and may either be provided in this manner to a user of the device 102 or cut to size by the user 110). One side of the film 106 may be coated with a surface adhesive 108 that adheres the film 106 to the device surface 104. The user 110 may manually estimate the alignment of the film 106 with respect to the device surface 104, and may position the film 106 on the device surface 104 for adherence with the static surface adhesive 108. In particular, in this exemplary scenario 100, the surface adhesive 108 comprises a static adhesive (e.g., a tacky substance) that adheres tightly upon contact with the device surface 104. However, due to the static adhesive property of tight adhesion upon contact, the user 110 may have difficulty accurately aligning the film 106 with the device surface 104, resulting in an excess 112 of film 106 at one edge of the device surface 104 and a shortage 114 of film 106 at another edge of the device surface 104. Additional disadvantages caused by misalignment may involve a skewed alignment of the film 106 (e.g., a non-orthogonal orientation of the film 106 with the device surface 104) or a warping of the film 108 resulting in seams or bubbles. Such disadvantages may reduce the protection of the device surface 104, as well as creating cosmetic flaws and/or functional impairment (e.g., the shortage 114 of film 106 may cause a visual inconsistency of the display and/or an inconsistent reading of touchscreen input by the device surface 104). Moreover, as a result, it may be difficult to reposition the film 106 after placement upon the device surface 104. Such repositioning may involve breaking the adhesive bonds established by the surface adhesive 108 between the film 106 and the device surface 104, and the adhesion of the repositioned film 106 may be weakened, subsequently resulting in premature detachment of the film 106 from the device surface 104.

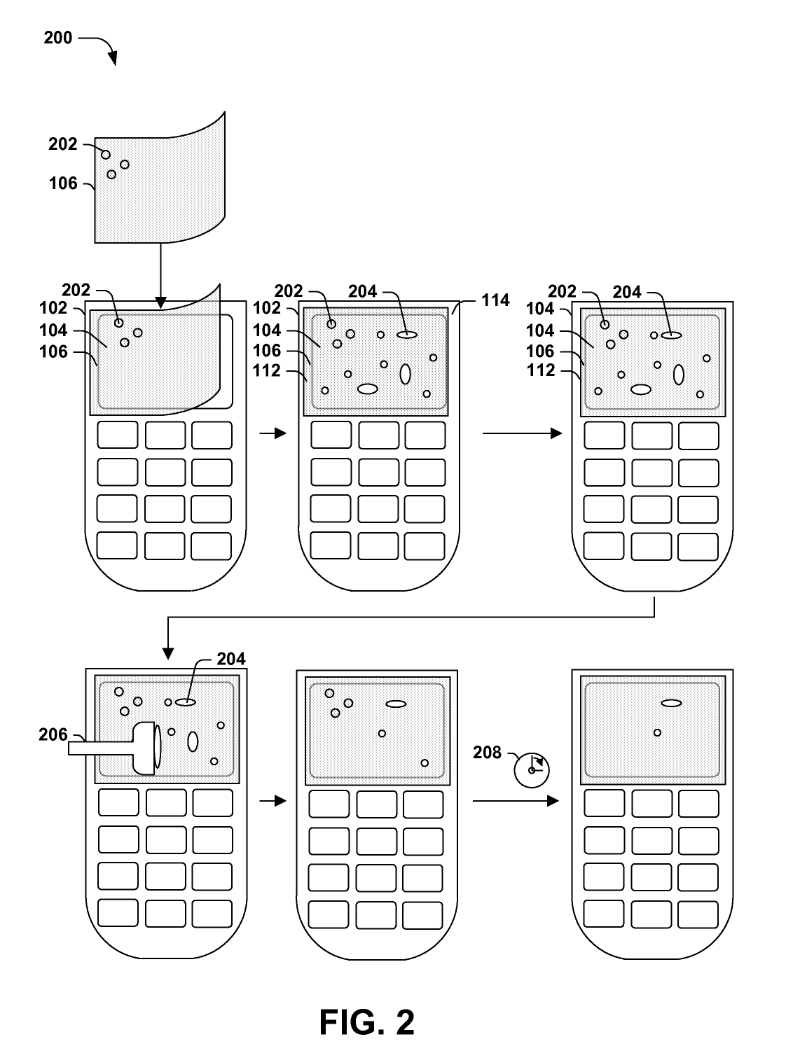

FIG. 2 presents an illustration of an exemplary scenario 200 featuring a second technique for applying a film 106 to a device surface 104 of a device 102. In this exemplary scenario 200, the film 106 comprises a dynamic surface adhesive 202 that is initially “deactivated” (not strongly adhesive), and that may become “activated’ (fully and tightly adhering to the device surface 104) in a subsequent step. The surface adhesive 202 may comprise a glue or paste, such as an adhesive material suspended in a fluid, such that when the fluid evaporates, the remaining adhesive material establishes a strong adhesive bond between the film 106 and the device surface 104. Accordingly, after initially applying the film 106 to the device surface 104 aligned in an approximate manner (e.g., having an overlap 112 and/or an underlap 114), a user 110 may realign the film 106 with respect to the device surface 104, e.g., by stretching, skewing, and sliding the film 106 to achieve a precise, desired alignment with the device surface 104. However, the fluid surface adhesive 202 may trap air bubbles 204 between the film 106 and the device surface 104. Such air bubbles 204 may cause cosmetic flaws and/or functional inconsistencies in the interface between the film 106 and the device surface 104. Accordingly, the user 110 may utilize a tool, such as a squeegee 206, to push the air bubbles 204 out from under the film 106 during the fluid phase of the surface adhesive 202. Having removed many of the air bubbles 204, the user 110 may refrain from using the device 102 for an activation period 208 during which the surface adhesive 202 establishes tight adhesive bonds with the device surface 104, resulting in an application of the film 106 in a well-aligned manner.

However, additional disadvantages may arise in the exemplary scenario 200 of FIG. 2. As a first example, the manual positioning and repositioning of the film 106 with respect to the device surface 104 of the device 102, followed by application of a squeegee 206 to remove air bubbles 204, may irritate to some users 110 due to the requisite extended period of attention and patience during the activation period 208. As a second example, even with the capability of realigning the film 106 with respect to the device surface 104 after initial contact, some users 110 may be unable to achieve an acceptable alignment due to poor vision, uncoordinated hands, and/or inaccurate visual judgment. As a third example, accidents during the manual handling of the film 106 prior to application to the device surface 104 (e.g., accidentally touching the side of the film 106 containing the surface adhesive 106) may result in contamination of the surface adhesive 106 with fingerprints or debris. As a fourth example, the manual placement and realignment of the film 106 may cause an excessive amount of air bubbles 204 to be trapped in the surface adhesive 106, and the removal of such excessive air bubbles 204 with a squeegee 206 may not be completely achievable. Moreover, the use of a squeegee 206 to remove air bubbles 204 may mar the outward surface of the film 106 (e.g., creating seams, tears, or deformed portions of the film 106), and extended use of the squeegee 206 to remove an excessive number of air bubbles 204 may exacerbate such disadvantages.

A third technique for applying a film 106 to a device surface 104 (not shown) involves a “self-wetting” adhesive, comprising a layer of adhesive applied between the film 106 and the device surface 104 that is more viscous than a liquid adhesive, but that is somewhat more dynamic than a tacky adhesive. The film 106 may be positioned and aligned on the device surface 104 while the “self-wetting” adhesive is in a moderately fluid and deactivated state, and some bubbles may be extruded from the surface adhesive 202 (e.g., through the use of a squeegee), before the surface adhesive 202 dries and activates to adhere the film 106 tightly to the device surface 104. Additionally, the moderately fluid nature of the “self-wetting” surface adhesive 202 may enable some air bubbles 204 trapped between the film 106 and the device surface 104 to escape through the semi-porous medium of the film 106. However, “self-wetting” surface adhesives 202 may present additional problems. As a first example, many air bubbles 204 may remain trapped within the surface adhesive 202 between the film 106 and the device surface 104. As a second example, it may be more difficult to squeegee air bubbles 204 out of the surface adhesive 202, due to the greater viscosity as compared with a liquid surface adhesive 202. As a third example, the greater viscosity and tackiness of a “self-wetting” surface adhesive 202, as compared with a liquid surface adhesive 202, may trap lint, dust, or other particles between the film 106 and the device surface 104. Such particles create additional difficulties using a squeegee 206 to remove air bubbles 204 out of the surface adhesive 202; e.g., large air bubbles 204 may pool around the trapped particle that are difficult to dislodge, and that do not completely escape through the film 106.

In view of these and other disadvantages, it may be desirable to apply the film 106 to the device surface 104 of the device 102 in a manner that reduces manual manipulation of the film 106. For example, it may be advantageous to devise a method of initially applying the film 106 in a manner that is accurately and precisely aligned with the device surface 104, and that does not necessarily rely upon the visual acuity, manual dexterity, and judgment of the user 110. The reduction in realignment of the film 106 may result in improved adhesion (due to reduced reformation of the adhesive bonds of the surface adhesive 202, or even the ability to use a more static adhesive), reduced frustration and contamination, and fewer air bubbles 204 resulting in reduced application of a squeegee 206 or other air bubble removal techniques.

### B. Presented Techniques

Presented herein are techniques for achieving the application of the film 106 to the device surface 104. In accordance with these techniques, it may be observed that many device surfaces 104 include one or more surface projections that interrupt the smooth device surface 104, such as apertures (e.g., a headphones port, a power or data port, or a recessed microphone) and protrusions (e.g., a convex button or switch, an extendable antenna, or a bezel surrounding a screen). In accordance with these techniques, an applicator may be fabricated comprising at least one anchor that is conformable with a surface projection of the device surface 104 of the device 102. For example, the applicator may include an anchor comprising a plug that may be inserted into a headphones port of the device 102. This anchoring may align the applicator to the device surface 104 with high accuracy and precision. Moreover, a film 106 may be coupled with the applicator (e.g., through a weak applicator adhesive) in such a manner that when the applicator is coupled with the device 102, the film 106 is also accurately and precisely aligned with respect to the device surface 104. Thus, the adhesion of the film 106 to the device surface 104, followed by removal of the applicator (e.g., by breaking the weak applicator adhesive coupling the applicator with the film 106), may result in an accurate alignment of the film 106 with the device surface 104 with reduced or no manual manipulation by the user 110.

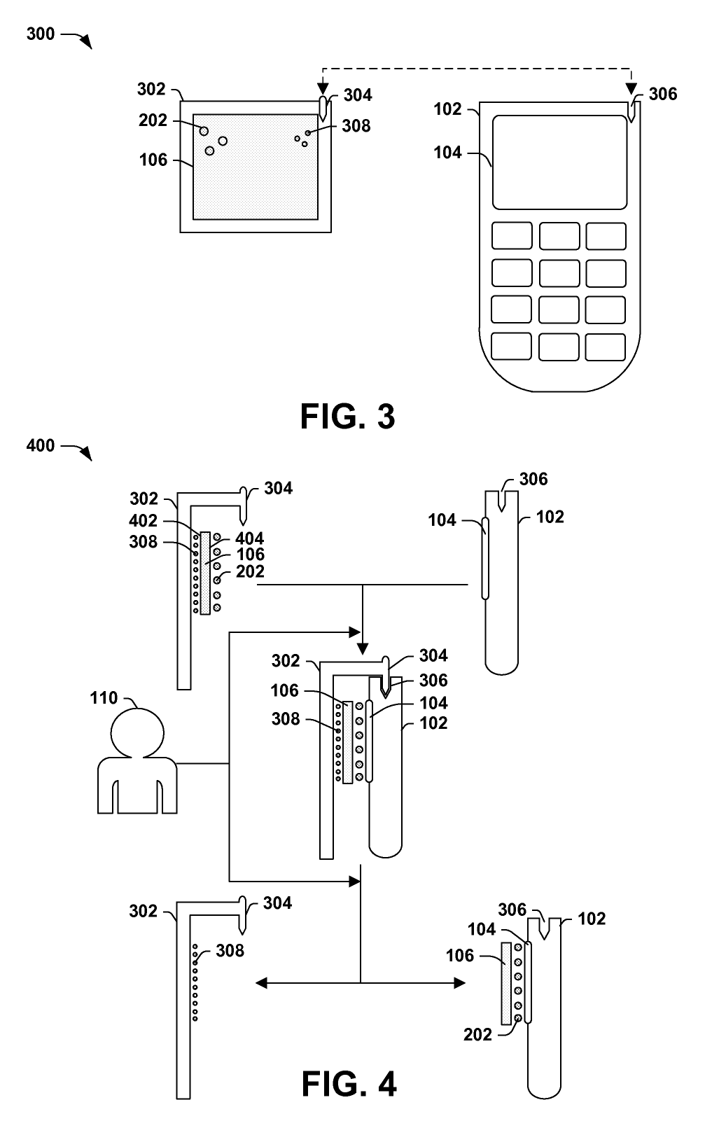

FIGS. 3-4 together present an illustration (respective presented as a front view and a side view) of an exemplary scenario 300, 400 featuring the application of a film 106 to a device surface 104 of a device 102 using an applicator 302. In the exemplary scenario 300 of FIG. 3, the applicator 302 includes an anchor 304, such as a plug that is rigidly molded with the applicator 302, and that is conformable with a surface projection 306 of the device 102, such as a headphones port. Moreover, the film 106 may be coupled with the applicator 106 in various ways. In this exemplary scenario 300, the film 106 is coupled with the applicator 106 using a comparatively weak applicator adhesive 308, such as a mildly tacky portion that attaches the film 106 to the applicator 302 and that may be broken by a gentle tug. (The applicator adhesive 308 is depicted with smaller circles than the surface adhesive 202 to connote the comparatively weaker adhesive strength of the applicator adhesive 308.) When the anchor 304 of the applicator 302 is coupled with the surface projection 306 of the device 102, the applicator 302 may be accurately aligned with the device surface 104, and the film 106 attached to the applicator 302 may also be aligned with the device surface 104. As further illustrated in the side view presented in FIG. 4, the film 106 may comprise an applicator surface 402 coupling the film 106 with the applicator 302 (e.g., via an applicator adhesive 308), and a film surface 404 comprising a surface adhesive 202 to be applied to the device surface 104. A user 110 may insert the anchor 304 of the applicator 302 into the surface projection 306 of the headphones port, thereby aligning the film 106 with the device surface 104. The user 110 may then separate the applicator 302 from the film 106, resulting in a properly aligned film 106 adhering to the device surface 104 of the device 102 without the involvement of manual alignment or realignment of the film 106 through the use of the techniques presented herein.

### C. Exemplary Embodiments

FIG. 4 also presents a first embodiment of these techniques, illustrated as an exemplary system for protecting a device surface 104 comprising at least one surface projection 306. The system comprises a film 106 sized according to the device surface 104 and comprising a surface adhesive 202 configured to attach a film surface 404 of the film 106 with the device surface 104. The exemplary system also comprises an applicator 302 comprising at least one anchor 304 that is conformable with a surface projection 306 of the device surface 104 (e.g., a protrusion conformable with an aperture of the device 102, or an aperture conformable with a protrusion of the device 102). The exemplary system also comprises an applicator adhesive 306 coupling an applicator surface 402 of the film 106 with the applicator 302, where such coupling accurately aligns the film 106 with the device surface 104 when at least one anchor 304 of the applicator 302 couples with a surface projection 306 of the device surface 104. The exemplary system utilized in the manner illustrated in the exemplary scenario 400 of FIG. 4 therefore enables an accurate and precise alignment of the film 106 with respect to the device surface 104.

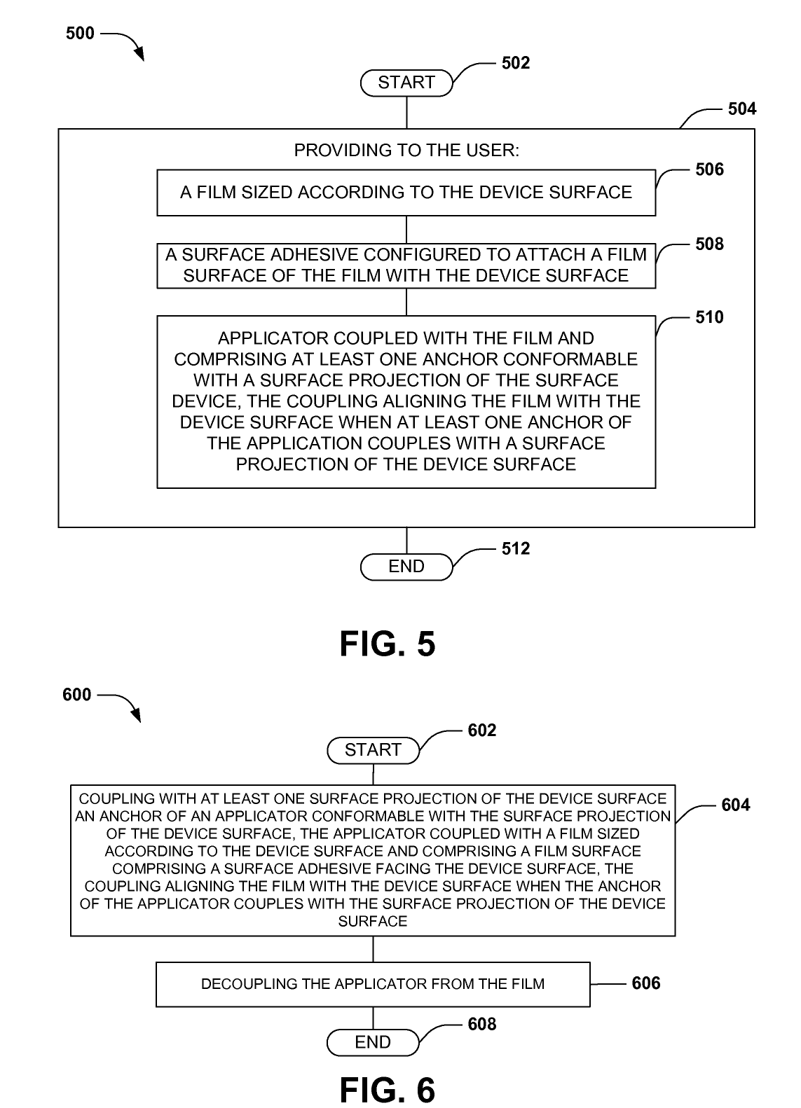

FIG. 5 presents a second embodiment of the techniques, illustrated as an exemplary method 500 of protecting a device surface 104 of a device 102 operated by a user 110, where the device surface 104 comprises at least one surface projection 306. The exemplary method 500 begins at 502 and comprises providing 504 to the user 110 the elements of the exemplary system illustrated in FIG. 4, such as a film 506 sized according to the device surface 104; a surface adhesive 508 configured to attach a film surface 404 of the film 106 with the device surface 104; an applicator 510 coupled with the film 506 and comprising at least one anchor 304 that is conformable with a surface projection 306 of the device surface 104. The coupling of the applicator 510 with the film 506 aligns the film 106 with the device surface 104 when at least one anchor 304 of the applicator 302 couples with a surface projection 306 of the device surface 104. Having provided 504 these elements to the user 110 (and possibly instructing the user 110 in the proper use thereof), the exemplary method 500 thereby achieves the facilitation of the user 110 in applying the film 106 to the device surface 104 of the device 102, and so ends at 512.

FIG. 6 presents a third embodiment of these techniques, illustrated as an exemplary method 600 of protecting a device surface 104 comprising at least one surface projection 302. The exemplary method 600 begins at 602 and involves coupling 604 with at least one surface projection 306 of the device surface 104 an anchor 304 of an applicator 302, where the anchor 304 is conformable with the surface projection 306 of the device surface 104. Additionally, the applicator 302 is coupled with a film 106 that is sized according to the device surface 104, and comprising a film surface 404 comprising a surface adhesive 202 facing the device surface 104. The coupling of the applicator 302 with the film 106 also aligns the film 106 with the device surface 104 when the anchor 304 of the applicator 302 couples with the surface projection 306 of the device surface 104. The exemplary method 600 also involves decoupling 600 the applicator 302 from the film 106. In this manner, the exemplary method 600 of FIG. 6 enables an application of the film 106 to the device surface 104 with accurate and precise alignment, and so ends at 608.

### D. Variations

The techniques discussed herein may be devised with variations in many aspects, and some variations may present additional advantages and/or reduce disadvantages with respect to other variations of these and other techniques. Moreover, some variations may be implemented in combination, and some combinations may feature additional advantages and/or reduced disadvantages through synergistic cooperation. The variations may be incorporated in various embodiments (e.g., the exemplary system of FIG. 4, the exemplary method 500 of FIG. 5, and the exemplary method 600 of FIG. 6) to confer individual and/or synergistic advantages upon such embodiments.

D1. Materials

A first aspect that may vary among embodiments of these techniques relates to the types of materials that may be used for various elements of such techniques. As a first such variation, many materials may be utilized as a film 106, including forms of urethane, polyurethane, polyester, polyethylene, and ethylene copolymers (e.g., Surlyn® packaging resin). Different materials may confer different degrees of properties that may be relevant in use as a protective film 106 for a device surface 104, such as plasticity (e.g., more rigid materials may provided improved deformation resistance, while more plastic materials may conform better to curved device surfaces 104); transparency (e.g., some materials may provide advantageous degrees of transmission, absorption, or reflection of different wavelengths of light, conferring properties such as high transparency, blocking sunlight, and high or low reflectivity); permeability of oxygen (smaller air bubbles 204 may permeate through the film 106); sensitivity to touch and other stimuli (e.g., compatibility with capacitative touch screens); resistance to scratches, pressure, and water damage; manufacturing cost; and recyclability.

As a second variation of this first aspect, different types of materials may be used for the applicator 302. For example, it may be advantageous to choose an inexpensive and recyclable material for applicators 302 that are likely disposed after use. Conversely, it may be advantageous to choose a durable material for applicators 302 that may be frequently re-used. As another example, it may be desirable to choose a material for the applicator 302 providing malleability that promotes molding into a desired shape (e.g., easy fabrication of the anchor 304); rigidity that resists deformation to retain precise coupling of the anchor 304 with the surface projection 306 and the resulting alignment of the film 106 with the device surface 104; and/or deformability that may enable an anchor 304 to conform to a range of surface projections 306. Additionally, different manufacturing techniques may be utilized to manufacture the applicator 302, such as a thermoforming process, wherein a plastic sheet is heated to induce pliability, molded and trimmed to form a desired shape, and cooled to set a durable form for the applicator 302.

As a third variation of this first aspect, many types of materials may be selected for the surface adhesive 202 that adheres the film 106 to the device surface 104, and/or for the applicator adhesive 308 that couples the film 106 with the applicator 302. Such adhesives may include static adhesives (e.g., persistently tacky adhesives) or dynamic adhesives (e.g., adhesives that are initially “deactivated,” but that may be “activated” through the passage of time, exposure to air or heat, or the addition of other chemicals). Different materials may also provide variations in properties that may be relevant to use as adhesives, such as adhesive strength (e.g., it may be desirable to choose a surface adhesive 202 that is sufficiently tight to resist unintentional removal, but that is sufficiently weak to enable intentional removal); cohesiveness (e.g., fluids may enable repositioning of the film 106); transparency (e.g., some materials may change transparency and color over time or in different conditions, such as heat or humidity); resistance to water and other chemicals; and health effects of exposure.

As a fourth variation of this first aspect, many techniques may be utilized to couple the applicator 302 with the film 106. As a first such example, the applicator 302 may be configured to hold a portion of the film 106, such as a clamp or slot into which an edge of the film may be inserted. As a second such example, the film 106 may be coupled with the applicator 302 through a coupling element, such a fastener that may be removed or broken away to decouple the applicator 302 from the film 106, or a piece of tape that may be peeled away to decouple the applicator 302 from the film 106. As a third example, a weak applicator adhesive 308 may couple the applicator 302 with the film 106. When the film 106 is coupled with the device surface 104, the applicator 302 may be pulled away from the film 106 and the device surface 104. If the applicator adhesive 308 is weaker than the surface adhesive 108, the pulling away may cause the applicator adhesive 308 to break before the surface adhesive 108.

As a fifth variation of this first aspect, the applicator 302 and film 106 may be coupled in various ways and at various times. As a first such example, the applicator 302 may be delivered to a user 110 with the film 106 pre-attached. Alternatively, the applicator 302 may include instructions guiding the user 110 to couple the film 106 with the applicator 302 in an aligned manner. In one such embodiment, the film 106 may comprise a cutout that corresponds to an anchor 304 of the applicator 302, such that when the film 106 is coupled with the anchor 304 of the applicator 302 and the anchor 304 is coupled with the surface projection 306 of the device surface 104, the film 106 is accurately aligned with the device surface 104. Those of ordinary skill in the art may identify many materials and many properties thereof that may be relevant for use in elements of the techniques presented herein.

D2. Applicator and Film Features

A second aspect that may vary among embodiments of these techniques relates to additional features that may be included with an applicator 302 and/or film 106. As a first such variation, the components of these techniques may include a set of instructions, such as a user instruction text (comprising text, symbols, icons, drawings, pictograms, and/or pictures) that may assist a user 110 in applying the film 106 to the device surface 104 through the use of the applicator 302. In one such embodiment, the user instruction text may be imprinted on the applicator 302.

As a second variation of this second aspect, additional elements may be included that alter the rigidity of the film 106. It may be appreciated that many films 106 are flexible, and that such flexibility may be problematic during the application of the film 106; e.g., the film 106 may bend, fold, or crease in undesirable ways during application to the device surface 104, which may cause the film 106 to adhere to itself; trap air, dust, or debris; cause deformation of the film 106, such as persistent creases or other inconsistencies in the film 106; and/or require delicate manipulation to correct, possibly resulting in fingerprints in the surface adhesive 108. Accordingly, it may be desirable to reduce the flexibility of the film 106 during the application of the film 106 to the device surface 104 of the device 102, and, moreover, to do so in a manner that may be reversed after such application. One such embodiment may include a stiffening element that is detachably coupled with the applicator surface 402 of the film 106 (e.g., a piece of cardboard of the shape of the film 106, coupled with the applicator surface 402 of the film 106 using a piece of tape or a weak adhesive) that may reduce the flexibility of the film 106 (e.g., causing the film 106 to retain a rigid, flat shape), and that may be removed after the film 106 is coupled with the device surface 104 of the device 102.

As a third variation of this second aspect, in addition to one or more anchors 304 that conform with one or more surface projections 306 of the device surface 104, an applicator 302 may include other features that assist with the alignment of the applicator 302 with the device surface 104, and, consequently, improve the alignment of the film 106 with the device surface 104. For example, the applicator 302 may include one or more lateral edges that conform with one or more device edge of the device 102, thereby providing another point of registration of the applicator 302 with the device 102 and device surface 104. Such registration features may also include optical guides (e.g., a portion of the applicator 302 that visually couples with a portion of the device 102 when the applicator 302 is correctly aligned with the device surface 104).

As a fourth variation of this second aspect, in addition to being sized according to the device surface 104, the film 106 may also be customized for the device surface 104 in other ways. As a first such example, the film 106 may be shaped to conform to a curve of the device surface 104. As a second such example, the film 106 may be manufactured with variable thickness corresponding to different areas of the device surface 104 (e.g., a thinner portion of the film 106 that overlays a touchscreen portion of the device surface 104). As a third example, the film 106 may feature one or more cutouts that are positioned and sized to, when the film 106 is aligned with the device surface 104, expose one or more device surface features of the device surface 104 (e.g., a cutout exposing an embedded microphone).

As a fifth variation of this second aspect, the surface adhesive 202 of the film 106 may be included as a separate component, e.g., a small vial or packet of adhesive that the user 110 may apply to the film surface 404 of the film 106 prior to application to the device surface 104. Alternatively, the surface adhesive 202 may be applied to the film 106 prior to provision to the user 110, but may be provided in a deactivated state, and may be activated prior to application to the device surface 104 (e.g., a dry adhesive coating the film surface 404 of the film 106 that is non-tacky when dehydrated, but that may be activated through the addition of water). As another alternative, the surface adhesive 202 may be provided to the user 110 with the film 106 in an activated state (e.g., a static adhesive), and may be protected from exposure prior to application to the device surface 104. For example, the film 106 may be provided to the user 110 with a surface adhesive protective film, which may be attached to the film surface 404 of the film 106 to protect the surface adhesive 202, and that, when separated from the film surface 404, exposes the surface adhesive 202 in an activated state. The surface adhesive protective film may be detached by peeling away from the film 106, and/or may include a surface adhesive protective film separation element that enables separation of the surface adhesive protective film from the film surface 404 of the film 102 (e.g., an overlapping tab of the protective film that the user 110 may grasp to peel away the protective film).

As a sixth variation of this second aspect, the film 106 may feature a film lifting element that enables a user 110 to lift a portion of the film 106 away from the device surface 104 while the surface adhesive 202 is in a deactivated state. For example, the film 106 may include a tab that the user 110 may grasp to lift a portion of the film 106, e.g., while repositioning the film 106 on the device surface 104. Moreover, the film lifting element may be detachable, e.g., a separate element that is coupled with the film 106 with a weak adhesive, or an separable element having a perforation that may be torn away from the film 106 or a line visually indicating a cut point to separate the film lifting element from the film 106. Those of ordinary skill in the art may devise many such additional features of the applicator 302 and film 106 that may be compatible with the techniques presented herein.

D3. Air Bubble Removal Features

A third aspect that may vary among embodiments of these techniques relates to the inclusion of features to facilitate the removal of air bubbles 204 that may become trapped in a fluid surface adhesive 202 between the device surface 104 and the film surface 404 of the film 106. As a first such variation, a material may be selected for the film 106 that features an oxygen permeability, whereby small air bubbles 204 may permeate through the film 106 to escape the surface adhesive 202. As a second such variation, the inclusion with the film 106 of a film lifting element may promote the removal of air bubbles 204, e.g., by enabling an incremental application of the film 106 to the device surface 104, and/or a removal and re-application of a portion of the film 106 trapping a large number of air bubbles 204.

As a third variation of this third aspect, the techniques presented herein may include a squeegee having a squeegee edge that, when pushed across an applicator surface 402 of the film 106 toward a film edge, pushes air bubbles trapped under the film 106 toward the film edge of the film 106. The use of the squeegee may be facilitated, e.g., through the inclusion of film lifting element, which may enable the user 110 to squeegee air bubbles 204 out of a first portion of the film 106 (lifting the film 106 away from the device surface 104 up to the film edge of the first portion) before applying a second portion of the film 106 to the device surface 104. The squeegee may be separately included in the techniques presented herein, and/or may be detachably coupled with the applicator 302 (e.g., manufactured with the applicator 302 with a perforated edge that may be broken apart to provide the squeegee to the user 110).

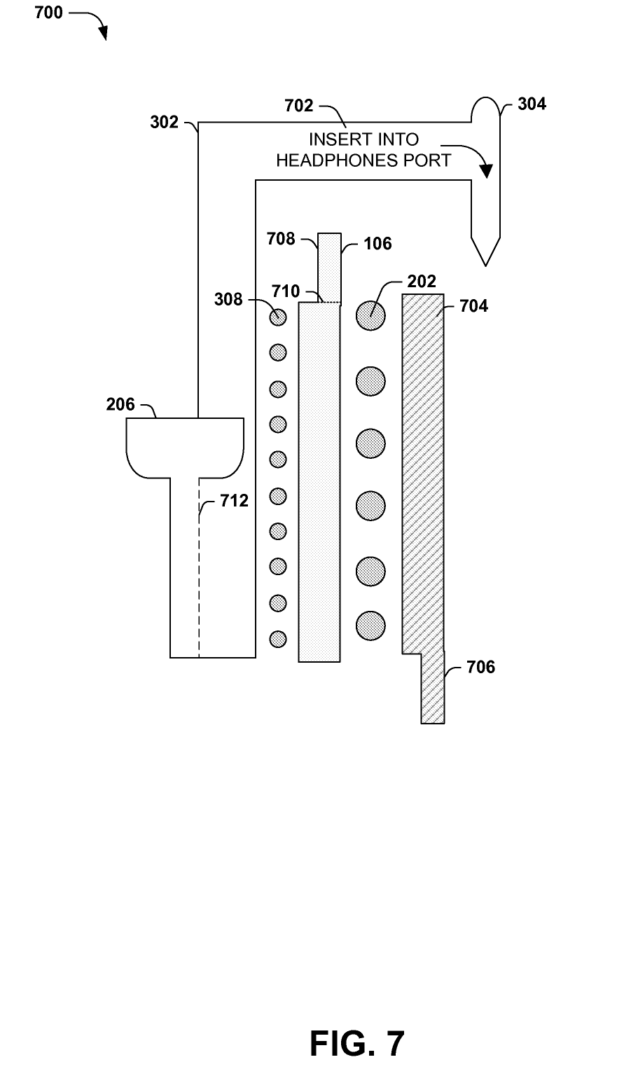

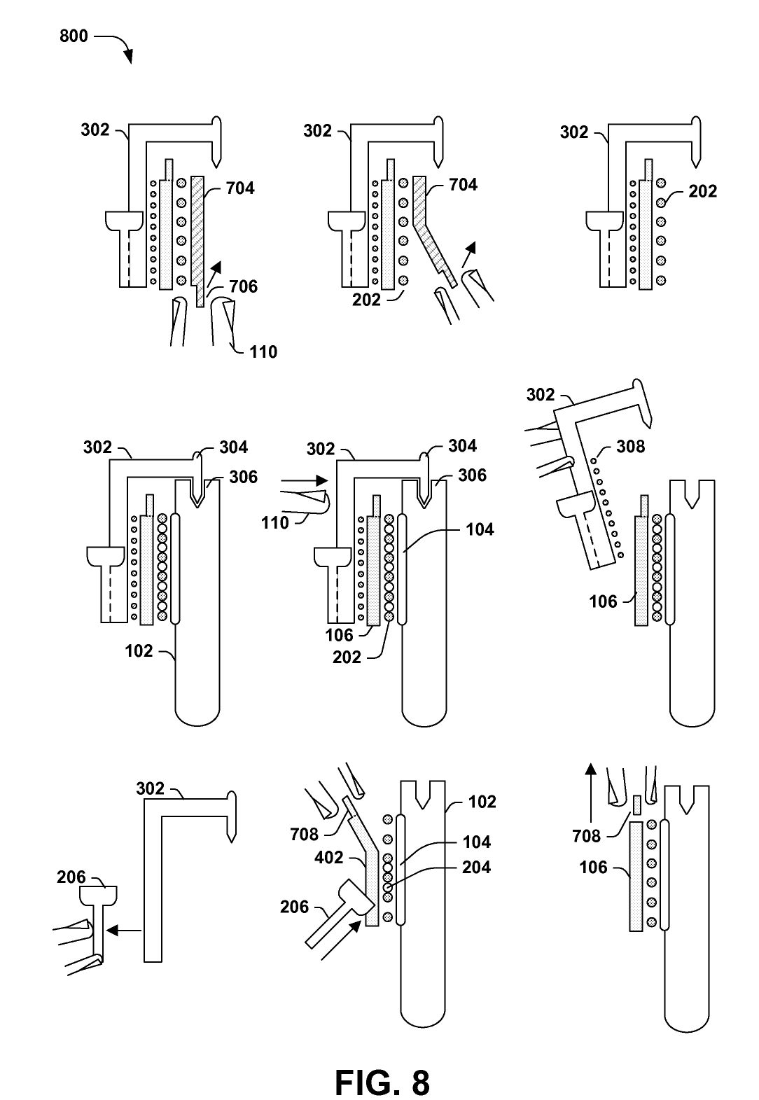

FIGS. 7-8 together illustrate, respectively, an applicator 302 and/or film 106 featuring several of the features discussed herein, and the use of such features during the application of the film 106 to the device surface 104. In the exemplary scenario 700 of FIG. 7, an applicator 302 is illustrated featuring an anchor 304 configured to conform with a surface projection 306 of a device surface 102 (e.g., a headphones port), and a film 107 comprising an adhesive 202 to be applied to the device surface 102 and coupled with the applicator 302 using an applicator adhesive 308. However, the exemplary scenario 700 of FIG. 7 also presents several other features. As a first example, the applicator 302 features a user instruction text 702 imprinted upon the applicator 302 to facilitate the use of the applicator 302. As a second example, the surface adhesive 202 is applied to the film 106, and is protected by a surface adhesive protective film 704 that may be removed prior to applying the film 106 to the device surface 104. Moreover, the surface adhesive protective film 704 includes a surface adhesive protective film separation element 706 (e.g., a tab) that may be grasped by the user 110 to facilitate separation of the surface adhesive protective film 704 from the film 106. As a third example, the film 106 includes a film lifting element 708 (e.g., a tab) that may be used to lift a portion of the film 106 away from the device surface 104 during application. The film lifting element 708 also includes a separation element 710 that facilitates removal of the film lifting element 708 after use. As a fourth example, the applicator 302 includes a squeegee 206 that is detachably coupled with the applicator 302 (e.g., through a perforated edge 712).

FIG. 8 presents an illustration of an exemplary scenario 800 depicting the use of these elements to apply the film 106 to the device surface 104. First, the user 110 may expose the film adhesive 202 by grasping the surface adhesive protective film separation element 706, and may peel the surface adhesive protective film 704 away from the film 106 to expose the surface adhesive 202. Next, the user 110 may couple the anchor 304 of the applicator 302 with the surface projection 306 of the device surface 104 (e.g., a plug fitting into a headphones port), thereby aligning the film 106 coupled with the applicator 302 with the device surface 104. The user 110 may also apply pressure to the applicator 302 to affix the film 106 to the device surface 104 while the film 106 is accurately aligned with the device surface 104. The user 110 may then remove the applicator 302 (e.g., pulling the applicator 302 away from the film 106 and thereby breaking the weak applicator adhesive 308), leaving the film 106 applied to and accurately aligned with the device surface 106. Next, the user 110 may detach the squeegee 206 from the applicator 302, grasp the film lifting element 708 of the film 106 to lift a portion of the film 106 away from the device surface 104, and may push the squeegee 206 across the applicator surface 402 of the film 106 to push air bubbles 204 trapped within the film adhesive 202 toward the film edge of the film 106 exposed by the lifting. After the film 106 is fully applied to the device surface 104, the user 110 may detach the film lifting element 708, leaving the film 106 applied to the device surface 104 with an accurate alignment and with reduced presence of air bubbles 204.

As a fourth variation of this third aspect, elements may be included to facilitate the removal of air bubbles 204 through the use of a squeegee 206. Some such embodiments may include one or more squeegee guides, which may guide the application of the squeegee 206 across the applicator surface 402 of the film 106, e.g., confining the area of the squeegeeing to the device surface 104 (and may block the inadvertent application of the squeegee 206 to other portions of the device 102 that are not protected by the film 106). This may be desirable, e.g., for reducing the unintended application of force to areas of the device 102 peripheral to the device surface 104 that may be marred by such force. The squeegee guides may be included in a separate element, or may be fabricated as part of the applicator 302 or film 106. Alternatively or additionally, the squeegee guide(s) may couple with one or more squeegee guide anchors on the squeegee 206 that may restrict the motion of the squeegee 206. As one such example, the applicator 302 may include a cup that couples with a knob of the squeegee 206 to allow rotation of the squeegee 206 across the device surface 104.

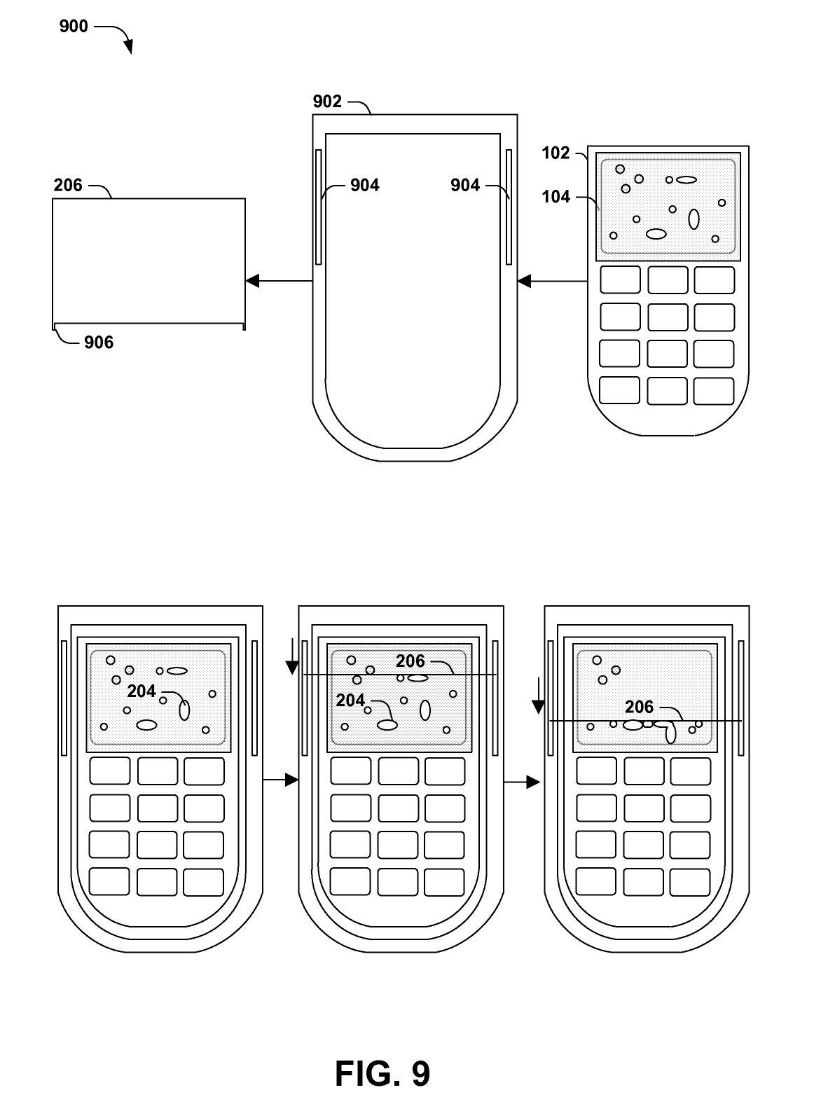

FIG. 9 presents an illustration of an exemplary scenario 900 featuring a second example of a squeegee 206 and the application thereof to remove air bubbles 204 trapped in a fluid surface adhesive 202 between the film 106 and the device surface 104. In this exemplary scenario 900, a tray 902 is included that conforms to the device 102, and that includes two squeegee guides 904 comprising lateral slots positioned along the edges of the tray 902, and the squeegee 206 comprises squeegee guide anchors 906 in the form of tabs that fit into the slots of the tray 902. After applying the film 106 to the device surface 104, the user 110 may place the device 102 in the tray 902 and then insert the squeegee guide anchors 906 of the squeegee 206 into the squeegee guides 904 of the tray 902. The user 110 may then press downward on the squeegee 206 (applying the squeegee 206 to the applicator surface 402 of the film 106) while moving the squeegee 206 vertically across the film 106, thereby forcing air bubbles 204 to the film edge of the film 106. In this manner, the use of the squeegee guides 904 in the tray 902 while applying the squeegee 206 to the film 106 may promote the removal of air bubbles 204 trapped under the film 106 while reducing the inadvertent exposure of other portions of the device 102 to the force of the squeegee 206. Those of ordinary skill in the art may devise many such techniques for removing air bubbles 204 that may be compatible with the techniques presented herein.

### E. Usage of Terms

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

The claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Moreover, the word “exemplary” is used herein to mean serving as an example, instance, or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A method of protecting a device surface of a device operated by a user, the device surface comprising at least one surface projection, the method comprising:
providing to the user:
a film sized according to the device surface;
a surface adhesive configured to attach a film surface of the film with the device surface;
an applicator coupled with the film and comprising at least one anchor conformable with a surface projection of the device surface, the coupling aligning the film with the device surface when at least one anchor of the applicator is coupled with a surface projection of the device surface.

2. A method of protecting a device surface comprising at least one surface projection, the method comprising:
coupling with at least one surface projection of the device surface an anchor of an applicator conformable with the surface projection of the device surface, the applicator coupled with a film sized according to the device surface and comprising a film surface comprising a surface adhesive facing the device surface, the coupling aligning the film with the device surface when the anchor of the applicator is coupled with the surface projection of the device surface; and
decoupling the applicator from the film.

3. A system for protecting a device surface comprising at least one surface projection, the system comprising:
a film sized according to the device surface;
a surface adhesive configured to attach a film surface of the film with the device surface;
an applicator coupled with the film and comprising at least one anchor conformable with a surface projection of the device surface, the coupling aligning the film with the device surface when at least one anchor of the applicator couples with a surface projection of the device surface.

4. The system of claim 3:
at least one surface projection comprising a recession in the device surface; and
an anchor of the applicator comprising a protrusion conformable with the recession of the device surface.

5. The system of claim 3:
at least one surface projection comprising a protrusion rising from the device surface; and
an anchor of the applicator comprising a recession conformable with the protrusion of the device surface.

6. The system of claim 3, the film comprising a polymer selected from a polymer set comprising:
a urethane;
a polyurethane;
a polyester;
a polyethylene; and
an ethylene copolymer.

7. The system of claim 3, comprising: an applicator adhesive coupling the film with the applicator that is weaker than the surface adhesive coupling the film with the device surface.

8. The method of claim 3:
the film comprising at least one cutout coupling with an anchor of the applicator; and
the anchor of the applicator configured to, when coupled with the surface projection of the device surface and a cutout of the film, align the film with the device surface.

9. The system of claim 3, the applicator comprising at least one lateral edge configured to conform with a device edge of a device comprising the device surface during aligning the film with the device surface.

10. The system of claim 3:
the device surface comprising at least one device surface feature; and
the film comprising at least one film cutout positioned and sized to, when the film is aligned with the device surface, expose the device surface feature.

11. The system of claim 3:
the surface adhesive applied to the film surface of the film; and
the system comprising: a surface adhesive protective film attached to the film surface of the surface adhesive configured to, when separated from the film surface, expose the surface adhesive for application to the device surface.

12. The system of claim 11, the surface adhesive protective film comprising: a surface adhesive protective film separation element configured to enable separation of the surface adhesive protective film from the film surface of the film.

13. The system of claim 11, comprising: a stiffening element coupled with an applicator surface of the film and reducing flexibility of the film during application of the film to the device surface of the device.

14. The system of claim 3, at least one film edge of the film comprising: a film lifting element configured to enable the film to be lifted away from the film surface after application of at least a portion of the film to the device surface.

15. The system of claim 3:
the surface adhesive comprising a fluid adhesive; and
the system comprising: a squeegee comprising a squeegee edge configured to, when pushed across an applicator surface of the film toward a film edge, push toward the film edge at least one air bubble trapped within the fluid adhesive between the film surface and the device surface.

16. The system of claim 15, the squeegee detachably coupled with the applicator.

17. The system of claim 15, comprising: at least one squeegee guide configured to guide the squeegee across the applicator surface of the film.

18. The system of claim 17, at least one squeegee guide embedded in a tray shaped to hold a device comprising the device surface during pushing the squeegee across the applicator surface of the film.

19. The system of claim 17, at least one squeegee guide embedded in the applicator.

20. The system of claim 19:
the squeegee guide comprising at least one squeegee guide anchor; and
the squeegee guide comprising at least one lateral edge of the applicator aligning with a portion of a surface edge of the device surface and configured to, when coupled with a squeegee guide anchor, guide movement of the squeegee across a length of the portion of the device surface while pushed across the applicator surface of the film.
